(19) United States
(12) Patent Application Publication
(10) Pub. No.: US 2006/0279129 A1
(43) Pub. Date: Dec. 14, 2006

(54) Safety improvement for restraint free ambulation device

(76) Inventor: Clifford H. Kraft, Naperville, IL (US)

Correspondence Address: Clifford Kraft, 320 Robin Hill Dr., Naperville, IL, 60540, US

(21) Appl. No.: 11/148,528

(22) Filed: Jun. 9, 2005

(51) Int. Cl. A47D 15/00; A62B 35/00

(52) U.S. Cl. 297/467

(57) ABSTRACT

A safety improvement for restraint free ambulation devices that prevents lateral and longitudinal tipping accidents by placing weights left and right of the centerline and on the lower part of the device's frame normally forward of the rear wheels. The weights can be contained in a member that runs laterally across the lower part of the frame. The weights can be metal, stone, sand or other heavy material. The amount and position of the weight can be adjustable to fit the needs of different patients. If a bar member is used, it can optionally extend slightly wider than the frame and its ends can be padded.

### BACKGROUND

1. Field of the Invention

The present invention relates to ambulation devices and more particularly to a safety improvement for an ambulation chair device.

2. Description of the Prior Art

Ambulation devices are used with partially impaired patients such as those with Altzheimer's disease and Parkinson's disease or those with weak legs or a tendency to fall when walking unassisted. They are very useful for elderly patients. In particular, a restraint free ambulation device is disclosed in U.S. Pat. No. 5,427,438 by Fochs. Fochs' device is a chair/walker with a chair seat mounted inside of a PVC pipe frame. The frame has wheels and can be closed around the patient (see FIG. 1). The patient can walk when he or she feels like it moving the ambulation device along behind. When the patient needs to sit, he or she can immediately sit down and rest. This is especially useful for patients that lack the strength to walk for long periods and who have a tendency to fall when walking unassisted. The device acts as a walking support with a following chair. patients who otherwise would not be allowed to walk in a facility such as a nursing home can walk using the device thus exercising and preserving their leg muscles. U.S. Pat. No. 5,427,438 is hereby incorporated by reference.

Patients using devices such as Fochs' are normally evaluated at a facility by a doctor or physical therapist for their ability to use the device without getting hurt because, unfortunately, Fochs' device has a problem: because it is so light weight (usually made of only PVC piping), if a patient tries to walk sideways in the device at the same time that one or more of the wheels is constrained, the device tips over causing the patient to fall with possibly serious consequences. A front and back wheel can easily become constrained. For example, the rear wheels have brakes which can be set by a nurse or staff member to prevent movement when a fixed location is desired. It is also very typical for patients to run the front wheels or the frame into an obstacle and still try to continue to walk. It is very common with these devices to see a demented patient still trying to walk with a front wheel up against an obstacle like a door frame and the rear wheel either against another obstacle or braked. In this and other similar situations, a patient attempting to walk sideways or to turn can easily tip the device over causing a dangerous fall.

A second dangerous mode exists where a tall patient sits and pushes very hard with their feet directly downward on the floor. Again, because of the lightness of the device, it tends to tip up on its back wheels creating a situation where a possible backward end-over-end tip over could occur.

For these reasons, seriously demented patients may not be allowed to use these devices, thus being deprived of their many benefits. Also, patients whose dementia is increasing may use the device successfully for a long period and then become too confused to use it anymore without danger, or worse yet, use it successfully for a long period of time and then suffer a fall in the device.

It would be advantageous to improve the device of to make it impossible for a demented patient to tip it over no matter which direction the patient tries to walk with respect to the major front-rear axis. It would also be advantageous to improve the device so that it is impossible to lift off the floor by a sitting patient no matter how hard they push downward on the floor.

### SUMMARY OF THE INVENTION

The present invention relates to an improvement to a restraint free ambulation device of the type made of a lightweight frame (a frame that is substantially lighter than the weight of the occupant) where the frame has a fore-aft centerline and a lower part where weights can be placed left and right of the front-aft centerline on the lower part of the frame proximate to the axis of the wheels to prevent lateral and fore-aft tipping accidents. A horizontal member containing the weights can run laterally across the lower part of said frame. A particular example of such a member can be a bar made from a piece of hollow PVC tubing of any cross-section. In general, the weights can be any heavy material including metal, stone, sand, concrete or other material. When such a member is used, the ends can be flush with the frame or extend further out laterally. The ends can be padded to prevent sharp edges. The bar can be attached to the frame with a clamp or by any other means.

### DESCRIPTION OF THE FIGURES

FIG. 1 shows the prior art Fochs device.

FIGS. 2A-2B show a side and front view of an embodiment of the improvement bar attached to a Fochs device.

FIG. 3 shows a cross-section of an embodiment of the improvement bar.

FIG. 4 shows a side view of an embodiment of the improvement bar with a padded end.

FIG. 5 shows an example of a lateral tipping mode.

FIG. 6 shows an example of a longitudinal tipping mode.

Several drawings and illustrations have been presented to aid in the understanding of the present invention. The scope of the present invention is not limited to the figures.

### DESCRIPTION OF THE INVENTION

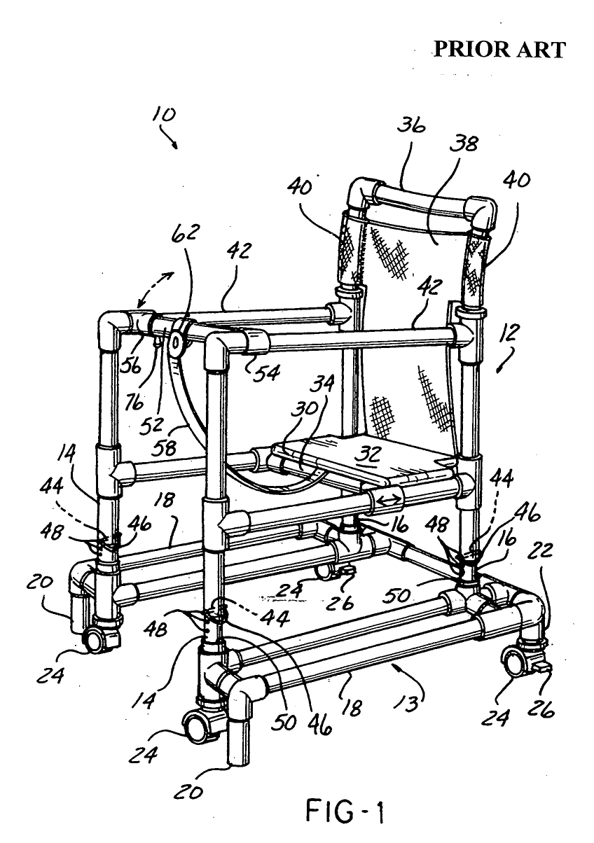

Turning to FIG. 1, the prior art restraint free ambulatory device of Fochs taught in U.S. Pat. No. 5,427,438 is shown. The frame of the device includes a lower outside rail (pipe) 13 on both sides with an apparent anti-tip leg 20. A patient normally stands (or sits) in the device with the front bar (extending from 54 to 56) closed. When the wheel brakes 26 are released, the patient can lean on the front bar (like a walker) and ambulate forward causing the wheels 24, 26 to roll as they walk. The device then acts as a wheeled walker. The problem occurs when the a front wheel 24 or anti-tip leg 20 hits an obstacle (like a door frame), and simultaneously, or soon thereafter, the rear wheel 24 on the same side encounters the same or a different obstacle (or has been braked by a staff member). In this mode (very common in the narrow crowed hallways of nursing homes), the device requires very little sideways force on the top horizontal bar 42 to tip it radically sideways where the opposite wheels lift up off the floor. At that point, a tiny amount more sideways force (such as the person leaning sideways or trying to ambulate sideways) causes the entire device to tip over sideways with possibly disastrous consequences for the patient.

A particular example is a demented Parkinson's patient who can normally move around in the device but who has lost cognition as to fact that they should only try to move the device forward when they walk. This type of patient does not realize that there is a problem attempting to walk sideways in the device. Walking sideways works as long as the wheels don't encounter obstacles (or the front wheel with the rear wheel braked); however, pushing sideways when the wheels have hit something can lead to a dangerous tip-over and fall, a particularly dangerous situation in a crowed nursing home corridor (with wheelchairs, patient lifting equipment, laundry baskets, food carriers, water carriers, scales and many other types of obstacles and fall contact points).

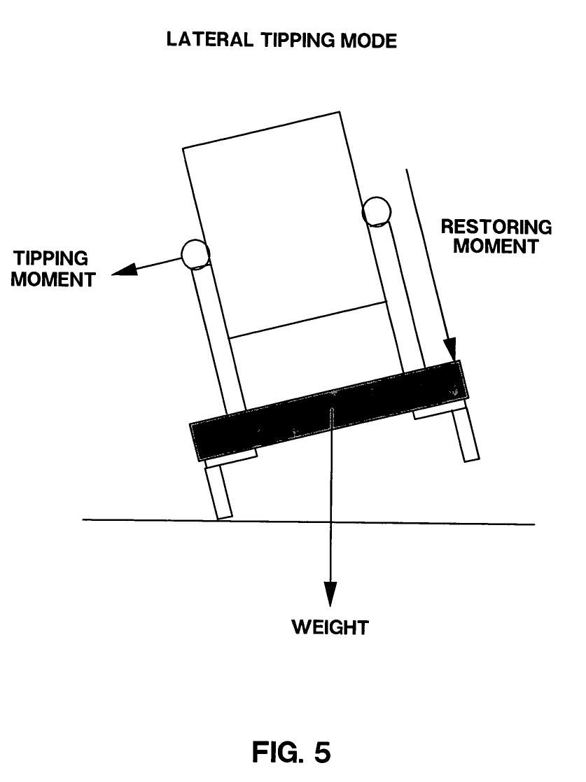

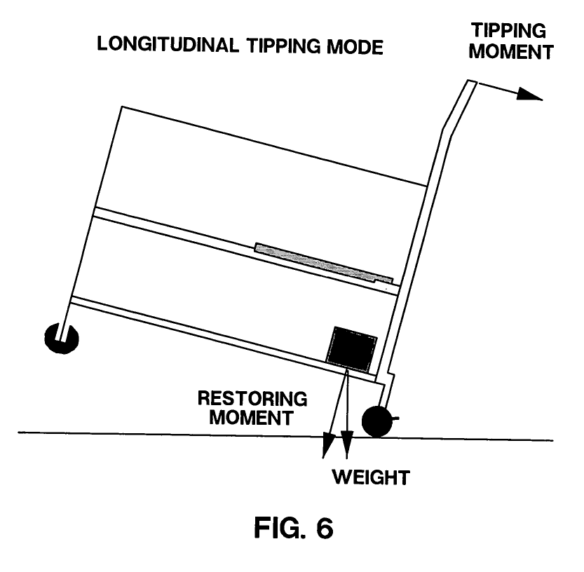

FIGS. 5-6 shows examples of the lateral and longitudinal tipping modes of the Fochs type ambulation devices. FIG. 5. shows that when an occupant of the device stands and leans or pushes sideways they can create a tipping moment with a lever arm extending to the floor, the fulcrum of which is an anti-trip leg in the front and a rear wheel in the back. The present invention provides a counterweight that provides a restoring moment as shown in FIG. 5. FIG. 6 shows a longitudinal tipping mode where the seated occupant pushes strongly downward on the floor creating a tipping moment against the back of the chair that causes the front wheels to lift off the ground. The present invention supplies a restoring moment to this mode also by supplying a counterweight forward of the rear wheels.

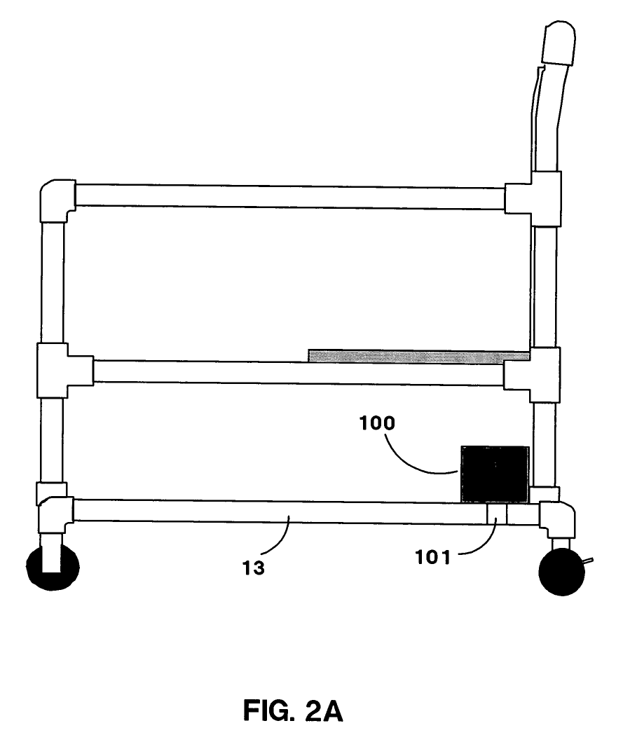

Turning to FIG. 2, an embodiment of the safety improvement of the present invention is seen. A member which can be a bar or tube 100 is installed and runs laterally from the left side of the device to the right side of the device. The bar 100 can be mounted anywhere; however, the most convenient place is under the seat (so as to not interfere with the patient's legs) at the rear of the device mounted on top of the lower fore-aft horizontal rails 13. The bar 100 can be attached to the rails 13 and/or to the rear verticals (that form the seat back). Attachment can be made by means of clamps 101 or by any means or method of attaching a bar to the frame. Alternatively, the bar 100 could be mounted below the front to back horizontal rails.

The member 100 should be heavier than the rest of the frame. A preferable weight is from around 20 lbs. to 40 or more pounds. The width of the bar 100 can be the same as that of the outer horizontal rails 13 or slightly wider. It should not be so wide as to obstruct free motion of the device. The presence of the bar 100 causes the device to now weight more than before and have a much lower center of gravity. The extra weight can cause a small amount of additional inertia in starting the chair to roll; however, this is normally slight since the wheels immediately start to turn.

Weight can be added to the device in many other ways including simply mounting weights on both sides at a low position. The key to preventing tipping is to cause the weight on the side of the device that is trying to lift in a potential tip-over to act as a lever arm countering the lever created by the patient pushing sideways on one of the top rails.

In the front-to-back tip-up case, the weight, being forward of the rear wheels, acts again as a lever or counterweight to hold the front down. This effect can be enhanced to any degree desired by simply mounting the weight slightly more forward. It has been found that mounting a bar weighing around 30 lbs. on the lower horizontal rails at a position under the seat as far aft as it will move before hitting the aft couplings on the lower rails (where they join the aft vertical rail) is entirely adequate to prevent tipping in any direction (either tipping mode). In this case, a member weighing 30 lbs. of length 34 inches was used. This bar extended beyond the 28 inch commercial width of the Fochs chair by 2 inches on each side. Tests show that a 28 inch bar works just as well. The test bar was constructed from a 4 inch square cross-section PVC fence post with several bricks contained in its interior. Any type of bar or weight container or weight is within the scope of the present invention.

The outboard ends of the horizontal bar or tube 100, if it extends beyond the frame, should normally be padded or covered so that there are no sharp edges that could harm the patient, staff or other patients.

The bar or weights can be clamped onto the frame such as with the clamps 101 shown in FIG. 2A. Any means of attaching the weight or weights to the frame is within the scope of the present invention.

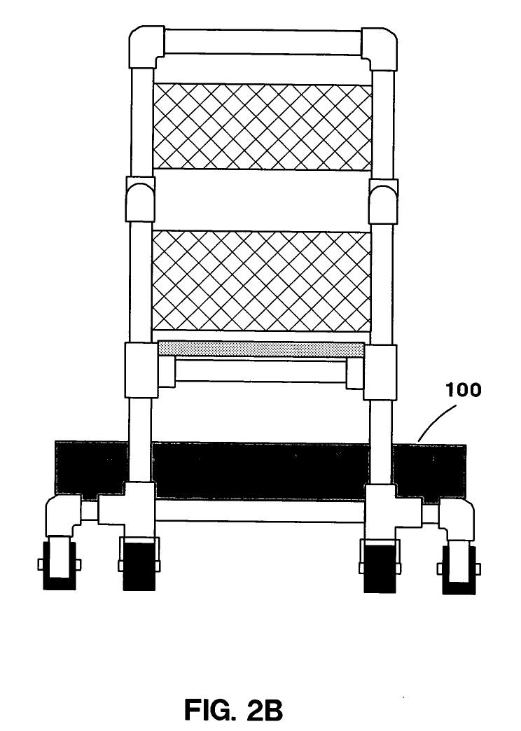

A preferred embodiment of the member 100 can contain a weight material 102 in its hollow cross-section as shown in FIG. 3. The amount of weight and the positions of weights can be adjusted to fit the needs of a particular patient. Any heavy material can be used as weight. The preferred material is metal such as aluminum, lead or steel; however, stone, brick or other heavy material can be used including sand, gravel or concrete. Steel generally provides the most weight for the cost. Lead provides the most weight in the smallest size. The weight material can be solid, blocks, granular, shot or any other configuration. It is important to place as much weight as far out left and right as possible to create the lever arm.

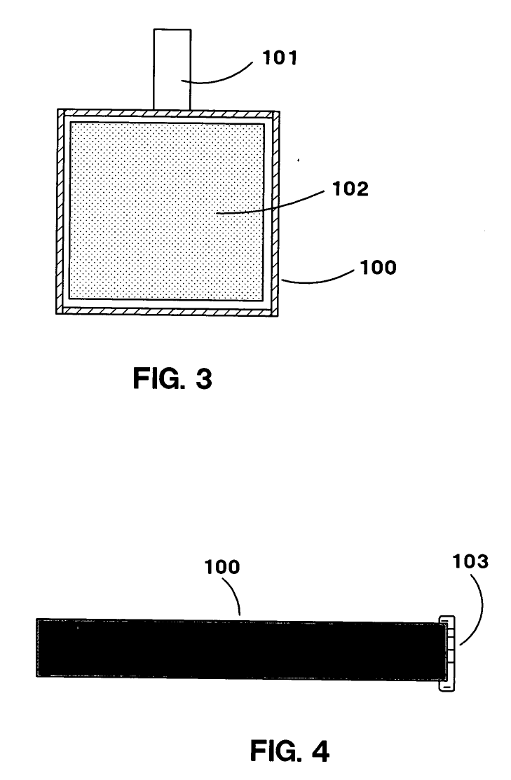

The improvement member 100 of the present invention can have any type of ends; however, for protection from sharp edges, the ends of the bar 100 can be covered with pads 103 as shown in FIG. 4. This is especially important if the length of the bar 100 is wider than the frame of the device.

Application of the present invention allows restraint free ambulatory devices to be safely used over a much wider class of patients who badly need the advantages they provide.

Several descriptions and illustrations have been presented to aid in the understanding of the present invention. A person skilled in the art will realize that many changes and variations are possible. All of these changes and variations are within the scope of the present invention.

I claim:

1. An improvement to a restraint free ambulation device of the type made of a low-weight frame, said frame having a fore-aft centerline and a lower part and an upper part with a plurality of wheels, the improvement comprising:
weight placed left and right of the front-aft centerline on the lower part of said frame proximate the axis of rotation of the wheels.

2. The improvement of claim 1 further comprising a horizontal bar containing said weights running laterally across the lower part of said frame.

3. The improvement of claim 1 wherein said bar is hollow PVC tubing.

4. The improvement of claim 1 wherein said weights are metal.

5. The improvement of claim 1 wherein said weights are stone or brick.

6. The improvement of claim 2 wherein said horizontal bar has two padded ends.

7. The improvement of claim 2 wherein said horizontal bar is clamped to said frame.

8. The improvement of claim 1 further comprising a means for attaching said weights to said frame.

9. The improvement of claim 2 further comprising a means for attaching said bar to said frame.

10. An ambulation device for an occupant, the weight of said ambulation device being substantially less than the weight of said occupant, comprising a frame with a plurality of structural components and a plurality of wheels, said device further comprising a member which provides a counterweight for opposing a tipping moment created by said occupant.

11. The ambulation device of claim 10 further comprising a member containing said counterweight running laterally across the lower part of said frame.

12. The ambulation device of claim 11 wherein said member is hollow PVC tubing.

13. The ambulation device of claim 10 wherein said counterweight is chosen from the group containing metal, stone, brick, concrete and sand.

14. The ambulation device of claim 11 wherein said member has at least one padded end.

15. The ambulation device of claim 11 wherein said member is clamped to said frame.

16. A method for preventing tip-over accidents in lightweight restraint free ambulation devices having frames with fore-aft centerlines and upper and lower parts comprising the step of attaching weights to the lower part of said frame to the left and right of said fore-aft centerline.

17. The method of claim 16 wherein said weights are contained in a member running laterally with respect to said fore-aft centerline.

18. The method of claim 16 wherein said weights are chosen from the group containing metal, stone, concrete, brick and sand.

19. The method of claim 17 wherein said member is attached to a rearward portion of said frame.

20. The method of claim 17 wherein said member has at least one padded end.
